(19) United States
(12) Patent Application Publication
(10) Pub. No.: US 2026/0292655 A1
(43) Pub. Date: Sep. 24, 2026

(54) USER EQUIPMENT BEHAVIOR WHEN NON-SATELLITE ACCESS IS NOT ALLOWED IN MOBILE COMMUNICATIONS

(71) Applicant: MediaTek Singapore Pte. Ltd., Singapore (SG)

(72) Inventors: Marko NIEMI, Oulu (FI); Puneet ., Bengaluru (IN)

(73) Assignee: MediaTek Singapore Pte. Ltd., Singapore (SG)

(21) Appl. No.: 19/474,547

(22) PCT Filed: Aug. 21, 2024
(86) PCT No.: PCT/CN2024/113568

§ 371 Date: Oct. 10, 2025

(30) Foreign Application Priority Data
Sep. 12, 2023 (IN) 202321061303
Sep. 12, 2023 (IN) 202321061304
Sep. 12, 2023 (IN) 202321061305
Sep. 12, 2023 (IN) 202321061306
Sep. 12, 2023 (IN) 202321061307

(51) Int. Cl. H04W 48/02; H04W 48/18; H04W 60/06; H04W 84/04

(52) U.S. Cl. CPC H04W 48/02; H04W 48/18; H04W 60/06; H04W 84/042

(57) ABSTRACT

Techniques pertaining to user equipment (UE) behavior when non-satellite access is not allowed in mobile communications are described. An apparatus (e.g., a UE) transmits, to a network, a request to access the network over a non-satellite access while the UE is not allowed to use the non-satellite access. In response, the apparatus receives, from the network, a reject message with a new reject cause. The new reject cause includes a reject cause that is either or both: (a) public land mobile network (PLMN)-specific and indicating the UE is not allowed to access a PLMN or an equivalent PLMN via the non-satellite access; and (b) covering all PLMNs and indicating the UE is not allowed to access any network via the non-satellite access.

### CROSS REFERENCE TO RELATED PATENT APPLICATION(S)

The present disclosure claims the priority benefit of Indian Patents Application Nos. 202321061303, 202321061304, 202321061305, 202321061306 and 202321061307, all filed 12 Sep. 2023, the contents of which herein being incorporated by reference in their entirety.

### TECHNICAL FIELD

The present disclosure is generally related to mobile communications and, more particularly, to user equipment (UE) behavior when non-satellite access is not allowed in mobile communications.

### BACKGROUND

In wireless communications such as mobile communications under the current 3^{rd} Generation Partnership Project (3GPP) specification, a network may reject a UE if the UE is requesting registration for a non-satellite access while the UE is not allowed to use the non-satellite access for its subscription or in the public land mobile network (PLMN). The UE behavior is not yet defined when the network (e.g., PLMN(s)) cannot allow the UE to use the non-satellite access. Therefore, there is a need for solutions of UE behavior when non-satellite access is not allowed in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to UE behavior when non-satellite access is not allowed in mobile communications. It is believed that implementations of one or more of the schemes proposed herein may address or otherwise alleviate the issues described above.

In one aspect, a method may involve a network receiving, from a UE, a request to access the network over a non-satellite access while the UE is not allowed to use the non-satellite access. The method may also involve the network rejecting the request by transmitting to the UE a reject message with a new reject cause. The new reject cause may include a reject cause that is either or both: (a) public land mobile network (PLMN)-specific and indicating the UE is not allowed to access a PLMN or an equivalent PLMN via the non-satellite access; and (b) covering all PLMNs and indicating the UE is not allowed to access any network via the non-satellite access.

In another aspect, a method may involve a UE transmitting, to a network, a request to access the network over a non-satellite access. The method may also involve the UE receiving, from the network, a reject message with a new reject cause. The new reject cause may include a reject cause that is either or both: (a) public land mobile network (PLMN)-specific and indicating the UE is not allowed to access a PLMN or an equivalent PLMN via the non-satellite access; and (b) covering all PLMNs and indicating the UE is not allowed to access any network via the non-satellite access.

It is noteworthy that, although the description provided herein may be in the context of certain radio access technologies, networks, and network topologies such as 5th Generation (5G)/New Radio (NR)/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4^{th} Generation (4G)/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of a second example process in accordance with an implementation of the present disclosure.

FIG. 4 is a flowchart of a second example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UE behavior when non-satellite access is not allowed in mobile communications. According to the present disclosure, a number of possible solutions may be implemented separately or jointly. That is, although these possible solutions may be described below separately, two or more of these possible solutions may be implemented in one combination or another.

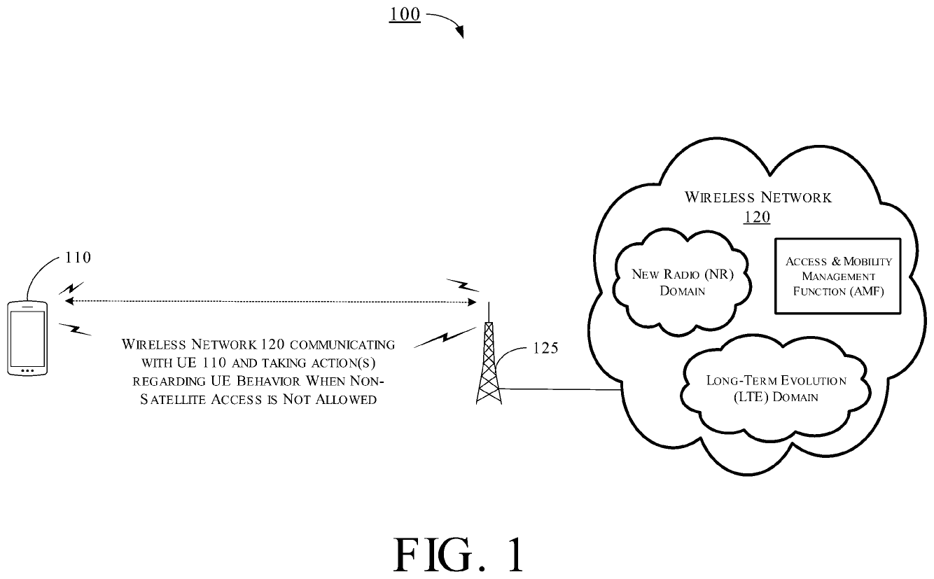

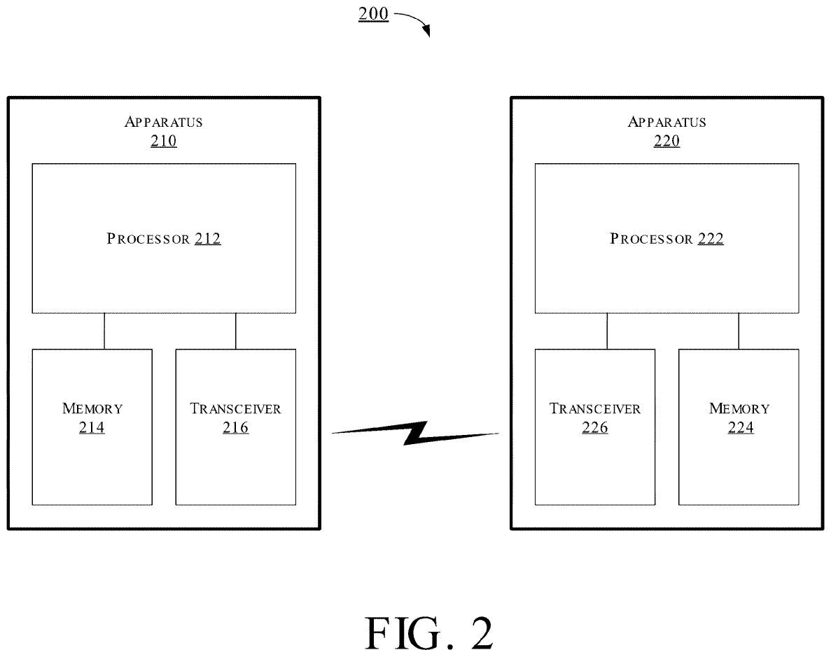

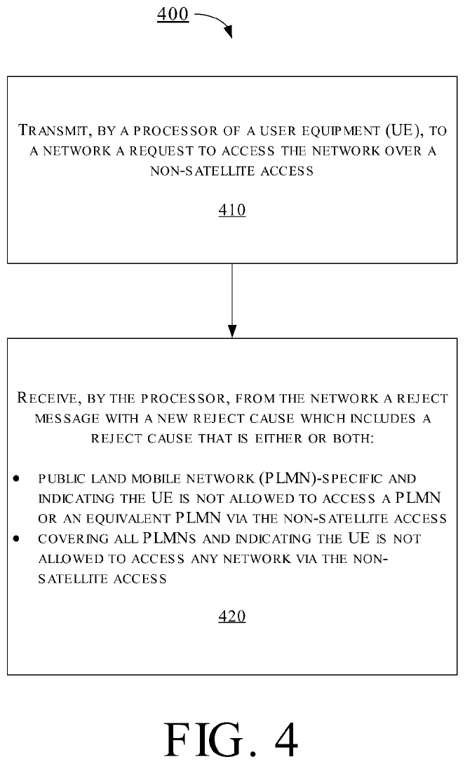

FIG. 1 illustrates an example network environment 100 in which various solutions and schemes in accordance with the present disclosure may be implemented. FIG. 2~FIG. 4 illustrate examples of implementation of various proposed schemes in network environment 100 in accordance with the present disclosure. The following description of various proposed schemes is provided with reference to FIG. 1~FIG. 4.

Referring to FIG. 1, network environment 100 may involve a UE 110, such as a mobile device or smartphone, in wireless communication with a wireless network 120 as part of a communication network. The wireless network 120 may be a PLMN including 5G/NR domain and 4G/LTE domain. UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to UE behavior when non-satellite access is not allowed in mobile communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

Under various proposed schemes in accordance with the present disclosure, a request by UE 110 to access network 120 over a non-satellite access may be rejected by network 120 with a new reject cause indicating that UE 110 is not allowed to access network 120 via the non-satellite access. The new reject cause may be: (1) PLMN-specific indicating that UE 110 is not allowed to access the PLMN (and/or its equivalent PLMNs) via the non-satellite access; and/or (2) covering all PLMNs (subscription based) indicating that UE 110 is not allowed to access any networks via non-satellite access(s).

Under one proposed scheme in accordance with the present disclosure with respect to new PLMN-specific reject cause for restricting use of non-satellite access in a PLMN, in case that UE 110 is rejected with the PLMN-specific new reject cause when UE 110 has requested services, or incase that network 120 initiates a detach or de-registration procedure indicating the cause when UE 110 was successfully registered over the non-satellite access, UE 110 upon receiving the reject from network 120 (e.g., a 5^{th} Generation System (5GS) network) may perform one, several or all of the operations described below.

For instance, UE 110 may set its 5GS update status as 5U3 ROAMING NOT ALLOWED. Alternatively, or additionally, UE 110 may delete a last visited registered tracking area identifier (TAI). Alternatively, or additionally, UE 110 may delete a TAI list. Alternatively, or additionally, UE 110 may delete a 5^{th} Generation Global Unique Temporary Identifier (5G-GUTI) in case that UE 110 is not registering or has not registered to the same PLMN over another access. Alternatively, or additionally, UE 10 may delete ngKSI (which consists of a value and a type of security context parameter indicating whether a 5G non-access stratum (NAS) security context is a native 5G NAS security context or a mapped 5G NAS security context) in case that UE 110 is not registering or has not registered to the same PLMN over another access. Alternatively, or additionally, UE 110 may enter the PLMN-SEARCH state. Alternatively, or additionally, UE 110 may enter the LIMITED-SERVICE state. Alternatively, or additionally, UE 110 may either consider the PLMN as forbidden and store “forbidden PLMN for (N1 mode) non-satellite access” or disable the N1 mode capability for non-satellite access for the PLMN. Alternatively, or additionally, in case that UE 110 considers the PLMN as forbidden, UE 110 may store the PLMN identity in a new forbidden list (e.g., “forbidden PLMNs for non-satellite access to 5GCN” or “forbidden PLMNs for non-satellite access”). Alternatively, or additionally, in case that UE 110 disables the N1 mode capability for non-satellite access for the PLMN, UE 110 may start a timer and enable the N1 mode capability for non-satellite access for the PLMN at expiry of the timer or universal subscriber identity module (USIM) removal or UE switch ON and OFF. Alternatively, or additionally, UE 110 may start T3245 timer in case that UE 110 is configured to use T3245 timer. Alternatively, or additionally, UE 110 may perform PLMN selection procedure. Alternatively, or additionally, UE 110 may maintain a new non-integrity protected counter (e.g., PLMN-specific attempt counters for non-satellite access). Alternatively, or additionally, UE 110 may set the new counter (PLMN-specific attempt counters for non-satellite access) for that PLMN to a UE implementation-specific maximum value, if the reject message has been successfully integrity checked by the NAS. Alternatively, or additionally, UE 110 may start T3540 timer for NAS signaling connection release. Alternatively, or additionally, UE 110 may handle Evolved Packet System (EPS) Mobility Management (EMM) parameters EMM state and/or EPS update status and/or 4^{th} Generation Global Unique Temporary Identifier (4G-GUTI) and/or last visited registered TAI and/or TAI list and/or eKSI and/or EMM attach attempt counter and/or tracking area updating attempt counter similar to 5^{th} Generation Mobility Management (5GMM) with the same cause value. Alternatively, or additionally, UE 110 may erase a new forbidden PLMN list upon T3245 expiry. Alternatively, or additionally, UE 110 may remove a selected PLMN from the new forbidden list when UE 110 gets registered on the selected PLMN over non-satellite cell. Alternatively, or additionally, UE 110 may start the T3247 timer when the new reject cause value is received as non-integrity protected. Alternatively, or additionally, UE 110 may increment the new counter (PLMN-specific attempt counters for non-satellite access) for that PLMN to the UE implementation-specific maximum value, if the message has been non-integrity checked by the NAS. Alternatively, or additionally, for each new counter (PLMN-specific satellite access attempt counter for non-satellite access) that has a value greater than zero and less than a UE implementation-specific maximum value, UE 110 may remove the respective PLMN from the list of new forbidden PLMN list (forbidden PLMNs for non-satellite access) upon T3247 expiry and/or when UE 110 is switched off and/or when the USIM is removed. Alternatively, or additionally, UE 110 may delete the PLMNs identified by the list in the REFRESH command from the new forbidden PLMN list, if stored, and UE 110 may enable N1 mode capability for non-satellite access for the PLMN, if disabled. Alternatively, or additionally, UE 110 may delete the PLMNs identified by the list of preferred PLMN/access technology combinations provided in steering of roaming (SOR) from the new forbidden PLMN list, if stored, and UE 110 may enable N1 mode capability for non-satellite access for the PLMN, if disabled. Alternatively, or additionally, UE 110 may ignore the contents of the new forbidden PLMN list, if stored, and UE 110 may enable N1 mode capability for non-satellite access for the PLMN, if disabled, for registration upon a manual mode selection of the PLMN by a user.

Under one proposed scheme in accordance with the present disclosure with respect to non-satellite access specific reject cause (access restricted by subscription), in case that UE 110 is rejected with a new reject cause restricting use of non-satellite access when UE 110 has requested services, or if network 120 initiates a detach or de-registration procedure indicating the cause when UE 110 was successfully registered over non-satellite access, UE 110 upon receiving the reject from network 120 (e.g., a 5GS network) may perform one, several or all of the operations described below.

For instance, UE 110 may set 5GS update status as 5U3 ROAMING NOT ALLOWED. Alternatively, or additionally, UE 110 may delete the last visited registered TAI. Alternatively, or additionally, UE 110 may delete TAI list. Alternatively, or additionally, UE 110 may delete 5G-GUTI in case that UE 110 is not registering or has not registered to the same PLMN over another access. Alternatively, or additionally, UE 110 may delete ngKSI in case that UE 110 is not registering or has not registered to the same PLMN over another access. Alternatively, or additionally, UE 110 may enter the PLMN-SEARCH state. Alternatively, or additionally, UE 110 may enter the LIMITED-SERVICE state. Alternatively, or additionally, UE 110 may disable the N1 mode capability for non-satellite access. Alternatively, or additionally, UE 110 may start a timer for disabling and enabling the N1 mode capability for non-satellite access for the PLMN at expiry of the timer or USIM removal or UE switch ON and OFF. Alternatively, or additionally, UE 110 may start T3245 timer in case that UE 110 is configured to use T3245 timer. Alternatively, or additionally, UE 110 may perform a PLMN selection procedure. Alternatively, or additionally, UE 110 may maintain a new non-integrity protected counter e.g. USIM/subscriber identity module (SIM) considered invalid for non-satellite access (all modes or just N1 mode). Alternatively, or additionally, UE 110 may set the new counter to the UE implementation-specific maximum value, if the message has been successfully integrity checked by the NAS. Alternatively, or additionally, UE 110 may start T3540 timer for NAS signaling connection release. Alternatively, or additionally, UE 110 may handle EMM parameters EMM state and/or EPS update status and/or 4G-GUTI and/or last visited registered TAI and/or TAI list and/or eKSI and/or EMM attach attempt counter and/or tracking area updating attempt counter similar to 5GMM with the same cause value. Alternatively, or additionally, UE 110 may erase the new forbidden PLMN list upon T3245 expiry. Alternatively, or additionally, UE 110 may start the T3247 timer when the new reject cause value is received as non-integrity protected. Alternatively, or additionally, UE 110 may increment the new counter, if the message has been non-integrity protected. Alternatively, or additionally, UE 110 may, upon T3247 expiry and/or when UE 110 is switched off and/or when the USIM is removed, set the SIM/USIM to valid for non-satellite services, if: (a) UE 110 does not maintain a counter for “SIM/USIM considered invalid for non-satellite services” events; or (b) UE 110 maintains a counter for “SIM/USIM considered invalid for non-satellite services” events and this counter has a value less than a UE implementation-specific maximum value).

Under one proposed scheme in accordance with the present disclosure with respect to applicability for other systems, such as General Packet Radio Service (GPRS), EPS, and 6^{th} Generation (6G), the proposed schemes described above may be applicable also in other systems, such as GPRS, EPS, 6G, WiMax, WiFi (or Wi-Fi), non-3^{rd} Generation Partnership Project (non-3GPP) access, for corresponding need to restrict UE 110 of using non-satellite access. Implementations of the above-described proposed scheme(s) may include certain methods, functions and/or parameters (not excluding others mentioned in above) such as, for example: (a) new reject cause(s) received from network 120; and (b) UE behavior at reception of reject cause such as: (i) maintaining new timer and other timers i.e. starting, stopping, behavior at expiry of a timer; (ii) maintaining different lists (e.g., new forbidden lists); and (iii) disabling/enabling of N1, S1, or other modes.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to UE behavior when non-satellite access is not allowed in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to UE behavior when non-satellite access is not allowed in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example processes 300 and 400.

### Illustrative Processes

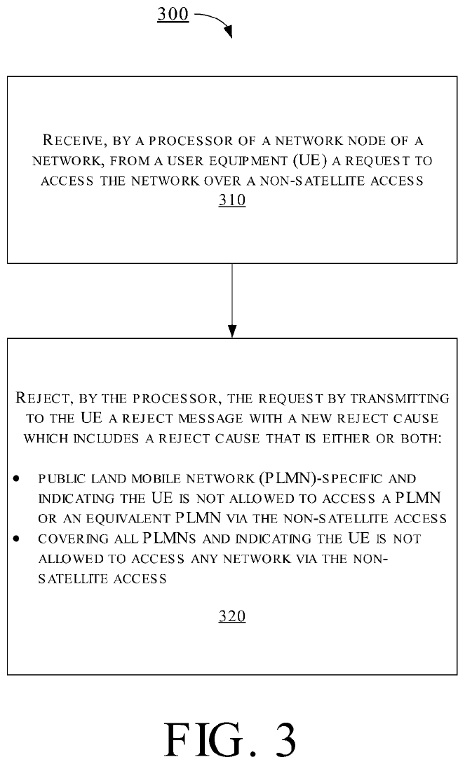

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to UE behavior when non-satellite access is not allowed in mobile communications in accordance with the present disclosure. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 222 of apparatus 220 receiving, via transceiver 226, from a UE (e.g., apparatus 210) a request to access the network over a non-satellite access while the UE is not allowed to use the non-satellite access. Process 300 may proceed from 310 to 320.

At 320, process 300 may involve processor 222 rejecting the request by transmitting, via transceiver 226, to the UE a reject message with a new reject cause. The new reject cause may include a reject cause that is either or both: (a) public land mobile network (PLMN)-specific and indicating the UE is not allowed to access a PLMN or an equivalent PLMN via the non-satellite access; and (b) covering all PLMNs and indicating the UE is not allowed to access any network via the non-satellite access.

In some implementations, in rejecting, process 300 may involve processor 222 rejecting with the PLMN-specific new reject cause when the UE has requested services.

In some implementations, in rejecting, process 300 may involve processor 222 rejecting as the network initiates a detach or de-registration procedure indicating the new reject cause when the UE was successfully registered over the non-satellite access.

In some implementations, in rejecting, process 300 may involve processor 222 rejecting with the new reject cause restricting usage of the non-satellite access when the UE has requested services.

FIG. 4 illustrates an example process 400 in accordance with an implementation of the present disclosure. Process 400 may represent an aspect of implementing various proposed designs, concepts, schemes, systems and methods described above. More specifically, process 400 may represent an aspect of the proposed concepts and schemes pertaining to UE behavior when non-satellite access is not allowed in mobile communications in accordance with the present disclosure. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively, in a different order. Furthermore, one or more of the blocks/sub-blocks of process 400 may be executed repeatedly or iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., network node 125) of a network (e.g., wireless network 120). Process 400 may begin at block 410.

At 410, process 400 may involve processor 212 of apparatus 210, as a UE, transmitting, via transceiver 216, to a network (e.g., wireless network 120 via apparatus 220 as network node 125) a request to access the network over a non-satellite access. Process 400 may proceed from 410 to 420.

At 420, process 400 may involve processor 212 receiving, via transceiver 216, from the network a reject message with a new reject cause. The new reject cause may include a reject cause that is either or both: (a) public land mobile network (PLMN)-specific and indicating the UE is not allowed to access a PLMN or an equivalent PLMN via the non-satellite access; and (b) covering all PLMNs and indicating the UE is not allowed to access any network via the non-satellite access.

In some implementations, responsive to the new reject cause being a new PLMN-specific reject cause that restricts usage of the non-satellite access in the PLMN, process 400 may involve processor 212 performing at least one of the following operations: (1) setting a 5GS update status as 5U3 ROAMING NOT ALLOWED; (2) deleting a last visited registered TAI; (3) deleting a TAI list; (4) deleting a 5G-GUTI in case the UE is not registering or has not registered to a same PLMN over another access; (5) deleting an ngKSI in case the UE is not registering or has not registered to the same PLMN over another access; (6) entering a PLMN-SEARCH state; (7) entering a LIMITED-SERVICE state; (8) considering the PLMN as forbidden and storing the identity of the PLMN in a new forbidden list; (9) disabling an N1 mode capability for a non-satellite access for the PLMN and starting a timer to enable the N1 mode capability for the non-satellite access for the PLMN at: (a) expiry of the timer, or (b) removal of a USIM, or (c) switching ON and OFF of the UE; (10) starting a T3245 timer in case the UE is configured to use the T3245 timer; (11) performing a PLMN selection procedure; (12) maintaining a new non-integrity protected counter as a PLMN-specific attempt counter for the non-satellite access; (13) setting the PLMN-specific attempt counters for the non-satellite access for the PLMN to a UE implementation-specific maximum value, in an event that the reject message has been successfully integrity checked by a NAS; (14) starting a T3540 timer for NAS signaling connection release; (15) handling EMM parameters EMM state or EPS update status or a 4G-GUTI or a last visited registered TAI or the TAI list or an eKSI or an EMM attach attempt counter or a tracking area updating attempt counter similar to 5GMM with a same cause value; (16) erasing a new forbidden PLMN list upon expiry of the T3245 timer; (17) removing a selected PLMN from the new forbidden list when the UE is registered on the selected PLMN over a non-satellite cell; (18) starting a T3247 timer when the new reject cause is received as non-integrity protected; (19) incrementing the PLMN-specific attempt counter for the non-satellite access for the PLMN to the UE implementation-specific maximum value, in an event that the reject message has been non-integrity checked by the NAS; (20) for each new counter that has a value greater than zero and less than a UE implementation-specific maximum value, removing a respective PLMN from a new forbidden PLMN list upon expiry of the T3247 timer or when the UE is switched off or when the USIM is removed; (21) deleting PLMNs identified by a list in a REFRESH command from the new forbidden PLMN list, if stored, and enabling the N1 mode capability for the non-satellite access for the PLMN, if disabled; (22) deleting the PLMNs identified by a list of preferred PLMN/access technology combinations provided in SOR from the new forbidden PLMN list, if stored, and enabling the N1 mode capability for the non-satellite access for the PLMN, if disabled; and (23) ignoring contents of the new forbidden PLMN list, if stored, and enabling the N1 mode capability for the non-satellite access for the PLMN, if disabled, for registration upon a manual mode selection of the PLMN by a user.

In some implementations, responsive to the new reject cause being a non-satellite access-specific reject cause used in restriction by subscription, process 400 may involve processor 212 performing at least one of the following operations: (1) setting a 5GS update status as 5U3 ROAMING NOT ALLOWED; (2) deleting a last visited registered TAI; (3) deleting a TAI list; (4) deleting a 5G-GUTI in case the UE is not registering or has not registered to a same PLMN over another access; (5) deleting an ngKSI in case the UE is not registering or has not registered to the same PLMN over another access; (6) entering a PLMN-SEARCH state; (7) entering a LIMITED-SERVICE state; (8) disabling an N1 mode capability for the non-satellite access; (9) starting a timer for disabling and enabling the N1 mode capability for the non-satellite access for the PLMN at: (a) expiry of the timer, or (b) removal of a USIM, or (c) switching ON and OFF of the UE; (10) starting a T3245 timer in case the UE is configured to use the T3245 timer; (11) performing a PLMN selection procedure; (12) maintaining a new non-integrity protected counter; (13) setting the new counter to a UE implementation-specific maximum value, if the reject message has been successfully integrity checked by a NAS; (14) starting a T3540 timer for NAS signaling connection release; (15) handling EMM parameters EMM state or EPS update status or a 4G-GUTI or a last visited registered TAI or the TAI list or an eKSI or an EMM attach attempt counter or a tracking area updating attempt counter similar to 5GMM with a same cause value; (16) erasing a new forbidden PLMN list upon expiry of the T3245 timer; (17) starting a T3247 timer when the new reject cause is received as non-integrity protected; (18) incrementing the new counter, if the reject message has been non-integrity protected; (19) upon expiry of the T3247 timer or when the UE is switched off or when the USIM is removed, setting a SIM or USIM to valid for non-satellite services, in an event that: (a) the UE does not maintain a counter for “SIM/USIM considered invalid for non-satellite services” events; or (b) the UE maintains the counter for the “SIM/USIM considered invalid for non-satellite services” events and this counter has a value less than a UE implementation-specific maximum value.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a network node of a network, from a user equipment (UE) a request to access the network over a non-satellite access while the UE is not allowed to use the non-satellite access; and
rejecting, by the processor, the request by transmitting to the UE a reject message with a new reject cause,
wherein the new reject cause comprises a reject cause that is either or both:
public land mobile network (PLMN)-specific and indicating the UE is not allowed to access a PLMN or an equivalent PLMN via the non-satellite access; and
covering all PLMNs and indicating the UE is not allowed to access any network via the non-satellite access.

2. The method of claim 1, wherein the rejecting comprises rejecting with the PLMN-specific new reject cause when the UE has requested services.

3. The method of claim 1, wherein the rejecting comprises rejecting as the network initiates a detach or de-registration procedure indicating the new reject cause when the UE was successfully registered over the non-satellite access.

4. The method of claim 1, wherein the rejecting comprises rejecting with the new reject cause restricting usage of the non-satellite access when the UE has requested services.

5. A method, comprising:
transmitting, by a processor of a user equipment (UE), to a network a request to access the network over a non-satellite access; and
receiving, by the processor, from the network a reject message with a new reject cause,
wherein the new reject cause comprises a reject cause that is either or both:
public land mobile network (PLMN)-specific and indicating the UE is not allowed to access a PLMN or an equivalent PLMN via the non-satellite access; and
covering all PLMNs and indicating the UE is not allowed to access any network via the non-satellite access.

6. The method of claim 5, wherein, responsive to the new reject cause being a new PLMN-specific reject cause that restricts usage of the non-satellite access in the PLMN, further comprising performing at least one of:
setting a 5^{th} Generation System (5GS) update status as 5U3 ROAMING NOT ALLOWED;
deleting a last visited registered tracking area identifier (TAI);
deleting a TAI list;
deleting a 5th Generation Global Unique Temporary Identifier (5G-GUTI) in case the UE is not registering or has not registered to a same PLMN over another access;
deleting an ngKSI in case the UE is not registering or has not registered to the same PLMN over another access;
entering a PLMN-SEARCH state;
entering a LIMITED-SERVICE state;
considering the PLMN as forbidden and storing the identity of the PLMN in a new forbidden list;
disabling an N1 mode capability for a non-satellite access for the PLMN and starting a timer to enable the N1 mode capability for the non-satellite access for the PLMN at:
expiry of the timer, or
removal of a universal subscriber identity module (USIM), or
switching ON and OFF of the UE;
starting a T3245 timer in case the UE is configured to use the T3245 timer;
performing a PLMN selection procedure;
maintaining a new non-integrity protected counter as a PLMN-specific attempt counter for the non-satellite access;
setting the PLMN-specific attempt counters for the non-satellite access for the PLMN to a UE implementation-specific maximum value, in an event that the reject message has been successfully integrity checked by a non-access stratum (NAS);
starting a T3540 timer for NAS signaling connection release;
handling Evolved Packet System (EPS) Mobility Management (EMM) parameters EMM state or EPS update status or a 4th Generation Global Unique Temporary Identifier (4G-GUTI) or a last visited registered TAI or the TAI list or an eKSI or an EMM attach attempt counter or a tracking area updating attempt counter similar to 5th Generation Mobility Management (5GMM) with a same cause value;
erasing a new forbidden PLMN list upon expiry of the T3245 timer;
removing a selected PLMN from the new forbidden list when the UE is registered on the selected PLMN over a non-satellite cell;
starting a T3247 timer when the new reject cause is received as non-integrity protected;
incrementing the PLMN-specific attempt counter for the non-satellite access for the PLMN to the UE implementation-specific maximum value, in an event that the reject message has been non-integrity checked by the NAS;
for each new counter that has a value greater than zero and less than a UE implementation-specific maximum value, removing a respective PLMN from a new forbidden PLMN list upon expiry of the T3247 timer or when the UE is switched off or when the USIM is removed;
deleting PLMNs identified by a list in a REFRESH command from the new forbidden PLMN list, if stored, and enabling the N1 mode capability for the non-satellite access for the PLMN, if disabled;
deleting the PLMNs identified by a list of preferred PLMN/access technology combinations provided in steering of roaming (SOR) from the new forbidden PLMN list, if stored, and enabling the N1 mode capability for the non-satellite access for the PLMN, if disabled; and
ignoring contents of the new forbidden PLMN list, if stored, and enabling the N1 mode capability for the non-satellite access for the PLMN, if disabled, for registration upon a manual mode selection of the PLMN by a user.

7. The method of claim 5, wherein, responsive to the new reject cause being a non-satellite access-specific reject cause used in restriction by subscription, further comprising performing at least one of:
setting a 5^{th} Generation System (5GS) update status as 5U3 ROAMING NOT ALLOWED;
deleting a last visited registered tracking area identifier (TAI);
deleting a TAI list;
deleting a 5th Generation Global Unique Temporary Identifier (5G-GUTI) in case the UE is not registering or has not registered to a same PLMN over another access;
deleting an ngKSI in case the UE is not registering or has not registered to the same PLMN over another access;
entering a PLMN-SEARCH state;
entering a LIMITED-SERVICE state;
disabling an N1 mode capability for the non-satellite access;
starting a timer for disabling and enabling the N1 mode capability for the non-satellite access for the PLMN at:
expiry of the timer, or
removal of a universal subscriber identity module (USIM), or
switching ON and OFF of the UE;
starting a T3245 timer in case the UE is configured to use the T3245 timer;
performing a PLMN selection procedure;
maintaining a new non-integrity protected counter;
setting the new counter to a UE implementation-specific maximum value, if the reject message has been successfully integrity checked by a non-access stratum (NAS);
starting a T3540 timer for NAS signaling connection release;
handling Evolved Packet System (EPS) Mobility Management (EMM) parameters EMM state or EPS update status or a 4th Generation Global Unique Temporary Identifier (4G-GUTI) or a last visited registered TAI or the TAI list or an eKSI or an EMM attach attempt counter or a tracking area updating attempt counter similar to 5th Generation Mobility Management (5GMM) with a same cause value;
erasing a new forbidden PLMN list upon expiry of the T3245 timer;
starting a T3247 timer when the new reject cause is received as non-integrity protected;
incrementing the new counter, if the reject message has been non-integrity protected;
upon expiry of the T3247 timer or when the UE is switched off or when the USIM is removed, setting a subscriber identity module (SIM) or USIM to valid for non-satellite services, in an event that:
the UE does not maintain a counter for “SIM/USIM considered invalid for non-satellite services” events; or
the UE maintains the counter for the “SIM/USIM considered invalid for non-satellite services” events and this counter has a value less than a UE implementation-specific maximum value.

8. An apparatus implementable in a user equipment (UE), comprising:
a transceiver configured to communicate wirelessly; and
a processor coupled to the transceiver and configured to perform operations comprising:
transmitting, via the transceiver, to a network a request to access the network over a non-satellite access; and
receiving, via the transceiver, from the network a reject message with a new reject cause,
wherein the new reject cause comprises a reject cause that is either or both:
public land mobile network (PLMN)-specific and indicating the UE is not allowed to access a PLMN or an equivalent PLMN via the non-satellite access; and
covering all PLMNs and indicating the UE is not allowed to access any network via the non-satellite access.

9. The apparatus of claim 8, wherein, responsive to the new reject cause being a new PLMN-specific reject cause that restricts usage of the non-satellite access in the PLMN, the processor is further configured to perform at least one of:
setting a 5^{th} Generation System (5GS) update status as 5U3 ROAMING NOT ALLOWED;
deleting a last visited registered tracking area identifier (TAI);
deleting a TAI list;
deleting a 5th Generation Global Unique Temporary Identifier (5G-GUTI) in case the UE is not registering or has not registered to a same PLMN over another access;
deleting an ngKSI in case the UE is not registering or has not registered to the same PLMN over another access;
entering a PLMN-SEARCH state;
entering a LIMITED-SERVICE state;
considering the PLMN as forbidden and storing the identity of the PLMN in a new forbidden list;
disabling an N1 mode capability for a non-satellite access for the PLMN and starting a timer to enable the N1 mode capability for the non-satellite access for the PLMN at:
expiry of the timer, or
removal of a universal subscriber identity module (USIM), or
switching ON and OFF of the UE;
starting a T3245 timer in case the UE is configured to use the T3245 timer;
performing a PLMN selection procedure;
maintaining a new non-integrity protected counter as a PLMN-specific attempt counter for the non-satellite access;
setting the PLMN-specific attempt counters for the non-satellite access for the PLMN to a UE implementation-specific maximum value, in an event that the reject message has been successfully integrity checked by a non-access stratum (NAS);
starting a T3540 timer for NAS signaling connection release;
handling Evolved Packet System (EPS) Mobility Management (EMM) parameters EMM state or EPS update status or a 4th Generation Global Unique Temporary Identifier (4G-GUTI) or a last visited registered TAI or the TAI list or an eKSI or an EMM attach attempt counter or a tracking area updating attempt counter similar to 5th Generation Mobility Management (5GMM) with a same cause value;
erasing a new forbidden PLMN list upon expiry of the T3245 timer;
removing a selected PLMN from the new forbidden list when the UE is registered on the selected PLMN over a non-satellite cell;
starting a T3247 timer when the new reject cause is received as non-integrity protected;
incrementing the PLMN-specific attempt counter for the non-satellite access for the PLMN to the UE implementation-specific maximum value, in an event that the reject message has been non-integrity checked by the NAS;
for each new counter that has a value greater than zero and less than a UE implementation-specific maximum value, removing a respective PLMN from a new forbidden PLMN list upon expiry of the T3247 timer or when the UE is switched off or when the USIM is removed;
deleting PLMNs identified by a list in a REFRESH command from the new forbidden PLMN list, if stored, and enabling the N1 mode capability for the non-satellite access for the PLMN, if disabled;
deleting the PLMNs identified by a list of preferred PLMN/access technology combinations provided in steering of roaming (SOR) from the new forbidden PLMN list, if stored, and enabling the N1 mode capability for the non-satellite access for the PLMN, if disabled; and
ignoring contents of the new forbidden PLMN list, if stored, and enabling the N1 mode capability for the non-satellite access for the PLMN, if disabled, for registration upon a manual mode selection of the PLMN by a user.

10. The apparatus of claim 8, wherein, responsive to the new reject cause being a non-satellite access-specific reject cause used in restriction by subscription, the processor is further configured to perform at least one of:
setting a 5^{th} Generation System (5GS) update status as 5U3 ROAMING NOT ALLOWED;
deleting a last visited registered tracking area identifier (TAI);
deleting a TAI list;
deleting a 5th Generation Global Unique Temporary Identifier (5G-GUTI) in case the UE is not registering or has not registered to a same PLMN over another access;
deleting an ngKSI in case the UE is not registering or has not registered to the same PLMN over another access;
entering a PLMN-SEARCH state;
entering a LIMITED-SERVICE state;
disabling an N1 mode capability for the non-satellite access;
starting a timer for disabling and enabling the N1 mode capability for the non-satellite access for the PLMN at:
expiry of the timer, or
removal of a universal subscriber identity module (USIM), or
switching ON and OFF of the UE;
starting a T3245 timer in case the UE is configured to use the T3245 timer;
performing a PLMN selection procedure;
maintaining a new non-integrity protected counter;
setting the new counter to a UE implementation-specific maximum value, if the reject message has been successfully integrity checked by a non-access stratum (NAS);
starting a T3540 timer for NAS signaling connection release;
handling Evolved Packet System (EPS) Mobility Management (EMM) parameters EMM state or EPS update status or a 4th Generation Global Unique Temporary Identifier (4G-GUTI) or a last visited registered TAI or the TAI list or an eKSI or an EMM attach attempt counter or a tracking area updating attempt counter similar to 5th Generation Mobility Management (5GMM) with a same cause value;
erasing a new forbidden PLMN list upon expiry of the T3245 timer;
starting a T3247 timer when the new reject cause is received as non-integrity protected;
incrementing the new counter, if the reject message has been non-integrity protected;
upon expiry of the T3247 timer or when the UE is switched off or when the USIM is removed, setting a subscriber identity module (SIM) or USIM to valid for non-satellite services, in an event that:
the UE does not maintain a counter for “SIM/USIM considered invalid for non-satellite services” events; or
the UE maintains the counter for the “SIM/USIM considered invalid for non-satellite services” events and this counter has a value less than a UE implementation-specific maximum value.
